(19) United States
(12) Patent Application Publication
(10) Pub. No.: US 2015/0033125 A1
(43) Pub. Date: Jan. 29, 2015

(54) METHOD AND APPARATUS FOR OPERATING WINDOW OF ELECTRONIC DEVICE WITH TOUCH SCREEN

(71) Applicant: SAMSUNG ELECTRONICS CO., LTD., Suwon-si (KR)

(72) Inventors: Jisook KANG, Daegu (KR); Hyunsuk CHOI, Daegu (KR); Sungjun KIM, Daegu (KR)

(21) Appl. No.: 14/328,085

(22) Filed: Jul. 10, 2014

(30) Foreign Application Priority Data
Jul. 29, 2013 (KR) 10-2013-0089370

(51) Int. Cl. G06F 3/0485

(52) U.S. Cl. CPC G06F 3/0485
USPC 715/719; 715/799

(57) ABSTRACT

A method of operating a window of an electronic device having a touch screen is provided. The method includes displaying a second window on a part of a first window, detecting a user input in the first window, and adjusting a position of the second window, when a distance between a position of the user input for the first window and the position of the second window is a preset threshold value or less.

### CROSS-REFERENCE TO RELATED APPLICATION(S)

This application claims the benefit under 35 U.S.C. §119(a) of a Korean patent application filed on Jul. 29, 2013 in the Korean Intellectual Property Office and assigned Serial number 10-2013-0089370, the entire disclosure of which is hereby incorporated by reference.

### TECHNICAL FIELD

The present disclosure relates to an electronic device. More particularly, the present disclosure relates to a method and an apparatus for operating a window of an electronic device having a touch screen capable of adjusting a position of a pop-up window from a manual operation to an automatic operation when performing multiple tasking.

### BACKGROUND

Recently, a portable terminal provides a pop-up window. The pop-up window corresponds to a window (e.g., a window according to a video watching) displayed in a form of a pop-up in a screen according to a user input. The pop-up window provides a help to a user so that the user may perform multitasking more conveniently.

The portable terminal may perform multitasking when the pop-up window is executed. However, the multitasking may have various problems. For example, when the user watches a video and performs a memo on the same screen simultaneously, a user input for the memo and the video playing may be overlapped in relation to each other. In this case, the user may be required to manually move a position of the video, and perform an input in the position at which the video is played. As a result, the user may be inconvenienced by having to spend time moving the position of the video by a manual operation.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for operating a pop-up window of a portable terminal capable of adjusting a position of the pop-up window according to user's multitasking from a manual operation to an automatic operation when operating the pop-up window of the portable terminal.

In accordance with an aspect of the present disclosure, a method of operating a window of an electronic device having a touch screen is provided. The method includes displaying a second window on a part of a first window, detecting a user input in the first window, and adjusting a position of the second window, when a distance between a position of the user input for the first window and the position of the second window is a preset threshold value or less.

In accordance with another aspect of the present disclosure, an apparatus of operating a window of an electronic device having a touch screen is provided. The apparatus includes a display unit configured to display a second window on a first window, a touch panel configured to detect a user input in the first window, a pop-up window position adjustment module configured to determine whether a distance between a position of the user input for the first window and a position of the second window is a preset threshold value or less, and a controller configured to control to adjust the position of the second window, when the distance is the preset threshold value or less as a result of the determination of the pop-up window position adjustment module.

In accordance with another aspect of the present disclosure, a method of automatically operating a window of an electronic device having a touch screen is provided. The method includes displaying a first window, displaying at least a part of a second window so as to overlap at least a part of the first window, and adjusting a display of the second window according to at least one of a user input to the first window, new information received in relation to the first window, and information being displayed in the first window.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a flowchart illustrating a method of operating a pop-up window when an electronic device executes multitasking according to an embodiment of the present disclosure;

FIGS. 3A, 3B, and 3C are diagrams illustrating a method of operating a pop-up window when an electronic device executes multitasking according to an embodiment of the present disclosure;

FIG. 4 is a flowchart illustrating a setting for a method of operating a pop-up window when an electronic device executes multitasking according to an embodiment of the present disclosure;

FIG. 5 is a flowchart illustrating a method of operating a pop-up window according to a drawing when an electronic device executes multitasking according to an embodiment of the present disclosure;

FIG. 6 is a flowchart for determining whether a data according to a drawing is overlapped with a second window when an electronic device executes multitasking according to an embodiment of the present disclosure;

FIGS. 7A, 7B, 7C, and 7D are diagrams illustrating a method of operating a pop-up window according to a user input when an electronic device executes multitasking according to an embodiment of the present disclosure;

FIG. 8 is a flowchart for determining whether an object according to a web page search is overlapped with a second window when an electronic device executes multitasking according to an embodiment of the present disclosure;

FIG. 9 is a flowchart illustrating a method of operating a pop-up window according to a hovering when an electronic device executes multitasking according to an embodiment of the present disclosure;

FIGS. 10A and 10B are diagrams illustrating user inputs according to a web page search when an electronic device executes multitasking according to an embodiment of the present disclosure;

FIG. 11 is a flowchart illustrating a method of operating a pop-up window according to a user input through a keypad when an electronic device executes multitasking according to an embodiment of the present disclosure; and

FIG. 12 is a diagram illustrating a method of operating a pop-up window according to a user input through a keypad when an electronic device executes multitasking according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Prior to a detailed description, an apparatus for operating a pop-up window according to various embodiments of the present disclosure may include a Smart Phone, a tablet Personnel Computer (PC), a Personal Digital Assistant (PDA), and the like. According to various embodiments of the present disclosure, the apparatus for operating a pop-up window may be an electronic device.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

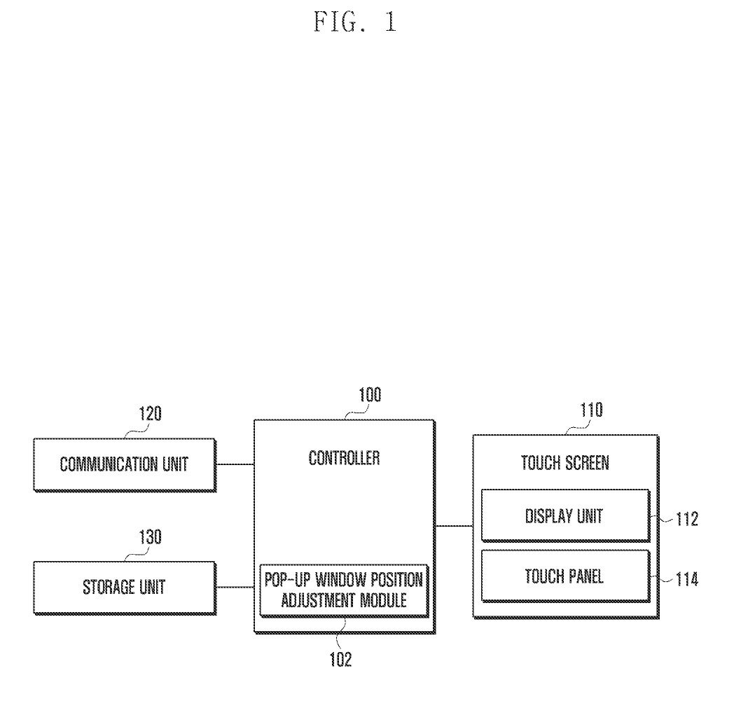

FIG. 1 is a block diagram illustrating a configuration of an electronic device according to an embodiment of the present disclosure.

Referring to FIG. 1, the electronic device of the present disclosure may include a controller 100, a touch screen 110, a communication unit 120, and a storage unit 130. The controller 100 may include a pop-up window position adjustment module 102.

The electronic device of the present disclosure may be implemented with more or fewer elements illustrated in FIG. 1.

For example, the electronic device may include various sensors (e.g., an infrared sensor, an illumination sensor, an image sensor, a proximity sensor, and/or the like) for detecting various user gestures, a Wireless Local Area Network (WLAN) module for supporting a wireless Internet, a short distance communication module for supporting various short distance communication technologies (e.g., a Bluetooth, a Bluetooth Low Energy (BLE), a Near Field Communication (NFC), and/or the like), a broadcast reception module for receiving a broadcast signal from an external broadcast management server through a broadcast channel (e.g., a satellite broadcast channel, a terrestrial broadcast channel, and/or the like), and/or the like.

The touch screen 110 may include a display unit 112 and a touch panel 114.

The display unit 112 may display various images in accordance with a use of the electronic device under the control of the controller 100. As an example, the various images may include a lock screen, a home screen, an app list screen, an app execution screen, a text input screen, and/or the like. The display unit 112 may process (e.g., decode) a data and store in a memory (e.g., a frame buffer) under the control of the controller 100, and may display the data stored in the frame buffer. In particular, the display unit 112 may display various screens according to an adjustment of position of pop-up window. For example, a user input in a first window (e.g., S-note) according to a multitasking may be assumed to be directed to a second window (e.g., a pop-up window according to video watching). The display unit 112 may display the first window, and display the second window on the first window. Further, the display unit 112 may display the user input in form of data under control of the controller 100.

Various screens output through the display unit 112 will be described in more detail with reference to diagrams illustrated later.

The touch panel 114 may be operated by a capacitive overlay type, a resistive overlay type, an infrared beam type, and/or the like. The touch panel 114 may generate a touch event in response to user's gesture for a screen, and may perform an Analog to Digital (AD) conversion for the touch event to transmit to the controller 100. The touch event includes at least one touch coordinate (x, y). For example, a touch-Integrated Circuit (IC) of the touch panel 114 may detect the user's touch, and may determine a touch area in response to a touch. The touch-IC may transmit the touch coordinate (x, y) included in the touch area to the controller 100. According to various embodiments of the present disclosure, the touch panel 114 may detect the user input in the first window for multitasking under the control of the controller 100. The user input may be a touch, a tap, a double-tap, a drag, a drawing, a swipe, multi-swipes, pinches, a flicking, a scrolling, a long press, a hovering, and/or the like.

The communication unit 120 may perform a voice call, a video call, or a data communication with an external device through a network under the control of the controller 100. The communication unit 120 may include a Radio Frequency (RF) transmitting unit for up-converting and amplifying a frequency of a transmitted signal and a RF reception unit for low-noise amplifying and down-converting a received signal. Further, the communication unit 120 may include a mobile communication module (e.g., 3-Generation mobile communication module, a 3.5-Generation mobile communication module, or a 4-Generation mobile communication module, and/or the like), a digital broadcast module (e.g., a Digital Multimedia Broadcasting (DMB) module), and a short distance communication module (e.g., Wi-Fi module, a Bluetooth module, and a NFC module), and/or the like.

The storage unit 130 may store a boot program, an operating system, and an application. In particular, the storage unit 130 may store a threshold value that can identify an input means (e.g., a touch pen or a finger, and/or the like) for the user input according to a multitasking. Further, the storage unit 130 may store a hovering threshold value for identifying proximity of the input means. The hovering threshold value may be set through a certain height (e.g., 3 cm, 2 cm, 1 cm, and/or the like) of the touch panel 114. The certain height may be configurable by a user.

The storage unit 130 may store a control data for the pop-up window position adjustment module 102. The control data may refer to a data which selects an operation mode or an attachment mode in a program, induces a sequential flow, directly affects an operation of software, and/or the like. The control data may be a data that actively moves the second window under the control of the controller 100, when at least one of coordinate value according to user input, a grid, a hovering, or a data for user input is directed to a position of the second window (e.g., a pop-up window according to a video watching). The position may be four sides of the second window, four corners, an output value or a center point connecting four sides or four corners, and/or the like.

The controller 100 may control an overall operation of the electronic device and a flow of signal between internal configurations of the electronic device, perform a function to process data, and control a power supply to the configurations from a battery. In particular, the controller 100 may detect an input for a first app execution, and execute a corresponding app. Further, when the first app is executed, the controller 100 may detect a user input for a second app execution, and execute a corresponding app. Further, the controller 100 may display the first window according to the first app and the second window according to the second app through the display unit 112.

When the first app and the second app are executed, the controller 100 may support multiple tasking. The controller 100 may detect the execution of the pop-up window position adjustment module 102. The execution of the pop-up window position adjustment module 102 may be executed through a voice input, a touch input, a key input, a default, and/or the like.

When the pop-up window position adjustment module 102 is executed, the controller 100 may be in a standby mode for detecting the user input. When the user input is detected in the first app (e.g., a main window according to a use of memo function), the controller 100 may control the pop-up window position adjustment module 102 so that the user input in the first app and the second app (e.g., a pop-up window according to a video watching) may not be overlapped.

In more detail, the user may perform a memo function in the first app. It may be assumed that the user input in the first app may be directed to the pop-up window according to the video watching. The controller 100 may detect the user input through at least one of user input position information such as a coordinate value, a grid, a hovering, or a data according to user input, and/or the like. Further, the controller 100 may recognize the position of the second window (e.g., four sides, four corners, an output value, or a center point connecting four sides or four corners, and/or the like).

Further, the controller 100 may measure a distance between the user input position information in the first window and the position of the second window through the pop-up window position adjustment module 102. When the distance becomes a threshold value (e.g., 3 cm, 2 cm, 1 cm, or less), the pop-up window position adjustment module 102 may automatically adjust the second window under control of the controller 100. The pop-up window position adjustment module 102 may automatically adjust a size, a shape, a positioning, and/or the like of the second window.

A description of the automatic adjustment will be described later in more detail with reference to a diagram.

According to various embodiments of the present disclosure, the pop-up window position adjustment module 102 is a module that adjusts the position of the pop-up window from a manual operation to an automatic operation. For example, the pop-up window position adjustment module 102 may be an adjustment module that adjusts the pop-up window by calculating the distance between the position information corresponding to the user input and the position of the pop-up window. The information corresponding to the user input may be a coordinate value, a grid, a hovering, or a data according to user input, and/or the like. The position of the pop-up window may be four sides, four corners, an output value, or a center point connecting four sides or four corners, and/or the like.

The pop-up window position adjustment module 102 may be included in the controller 100. Further, the pop-up window position adjustment module 102 may be included in an element that is not the controller 100. For example, the pop-up window position adjustment module 102 may be included in the storage unit 130 (e.g., outside the controller 100).

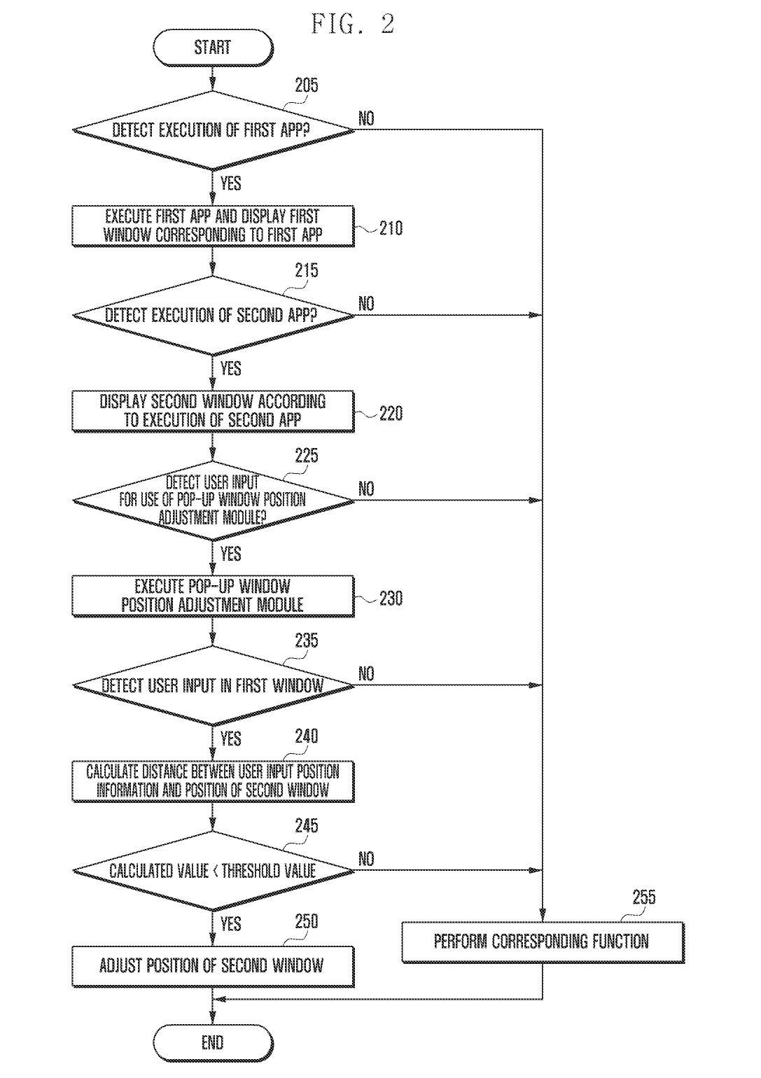

FIG. 2 is a flowchart illustrating a method of operating a pop-up window when an electronic device executes multitasking according to an embodiment of the present disclosure.

Referring to FIG. 2, the controller 100 may be in a standby state for detecting a user input in the standby screen of the electronic device. At operation 205, the controller 100 may detect the user input for the execution of the first app. The user input may be a voice input, a touch input, a key input, and/or the like.

At operation 210, when detecting the user input for the execution of the first app, the controller 100 may display the first window (e.g., a main window according to an execution of a memo function) corresponding to the first app on the display unit 112 by executing the first app. For example, in response to detecting the user input for executing the first app, the controller may execute the first app and display the first window corresponding to the first app. The first app may be provided based on user preference such as an Internet search, a listening to music, a watching video, a game, and/or the like. In addition, the first app may be provided based on user's task such as deposit, inventory management, seat reservations, and/or the like.

When the first window is displayed according to the execution of the first app, the controller 100 may be in a standby state for detecting the user input. The user input may be a voice input according to the execution of the second window, a touch input, a key input, and/or the like. The controller 100 may detect the user input according to the execution of the second app.

At operation 215, the controller 100 may determine whether a user input according to execution of the second app is detected.

If the controller 100 determines that the user input according to execution of the second app is not detected at operation 215, then the controller 100 may proceed to operation 255 at which the controller 100 performs a corresponding function.

In contrast, if the controller 100 determines that the user input according to execution of the second app is not detected at operation 215, then the controller 100 may proceed to operation 220 at which the controller 100 may display the second window (e.g., a pop-up window according to a video watching) according to the execution of the second app on the display unit 112. Further, the controller 100 may support the display of the second window to be displayed on a portion of the first window. Further, the controller 100 may distinguish the first window from the second window.

In the meantime, assuming that the window according to the execution of the first app is the first window (e.g., main window), the window according to the execution of the second app may be supported as the second window (e.g., a pop-up window). In contrast, when executing the second app during the execution of the first app, the first window corresponding to the first app may be supported as the second window. For example, assuming that the app according to the video watching is executed, the window according to a corresponding video watching may be displayed on the display unit 112 as the first window (e.g., main window). The controller 100 may detect the execution of the second app according to user intention.

When the user input according to the execution of the second app is detected, the second window corresponding to the second app may be displayed on the display unit 112. In this case, the second app may be assumed to be an app according to use of the memo function and the first app being executed may be assumed to be an app for watching video. The controller 100 may display the second window according to the second app which is executed later as the first window based on a priority. For example, the controller 100 may determine the priority for respective executed apps according to the intention of the user, and distinguish the first window (e.g., main window) supported on the display unit 112 or the second window (e.g., a pop-up window).

When the first app and the second app are executed, the controller 100 may display the second window (e.g., a pop-up window) according to the execution of the second app on a portion of the first window (e.g., main window) according to the execution of the first app on the display unit 112. The controller 100 may detect the user input for the use of the pop-up window position adjustment module 102. The user input may be a voice input, a button input, a key input, and/or the like.

At operation 225, the controller 100 may determine whether a user input for use of a pop-up window adjustment module is detected.

If the controller 100 determines that a user input for use of a pop-up window adjustment module is not detected at operation 225, then the controller 100 may proceed to operation 255 at which the controller 100 may perform a corresponding function.

In contrast, if the controller 100 determines that a user input for use of a pop-up window adjustment module is detected at operation 225, then the controller 100 may proceed to operation 230 at which the controller 100 may execute the pop-up window position adjustment module 102 according to the user input.

When the pop-up window position adjustment module 102 is executed, the controller 100 may be in a standby state for detecting a user input for multitasking. The controller 100 may detect the user input in the first window (e.g., a main window according to an execution of a memo function). The user input may be a touch, a tap, a double-tap, a drag, a drawing, a swipe, multi-swipes, pinches, a flicking, a scrolling, a long press, a hovering, and/or the like.

At operation 235, the controller 100 may determine whether a user input in the first window is detected.

If the controller 100 determines that a user input in the first window is not detected at operation 235, then the controller 100 may proceed to operation 255 at which the controller may perform a corresponding function.

In contrast, if the controller 100 determines that a user input in the first window is detected at operation 235 (e.g., when the user input is detected in the first window), then the controller 100 may proceed to operation 240 at which the controller 100 may calculate the distance between the user input position information in the first window and the position of the second window. The user input position information may be a coordinate value, a grid, a hovering, or a data according to user input, and/or the like. Further, the position may be four sides of the second window, four corners, an output value, a center point connecting four sides or four corners, and/or the like.

At operation 245, the controller 100 may determine whether a calculated value is less than a threshold value (e.g., whether the calculated distance between the user input position information in the first window and the position of the second window is less than a threshold value).

If the controller 100 determines that the calculated value is not less than a threshold value (e.g., if the calculated distance between the user input position information in the first window and the position of the second window is not less than a threshold value) at operation 245, then the controller 100 may proceed to operation 255 at which the controller 100 may perform a corresponding function.

In contrast, if the controller 100 determines that the calculated value is less than a threshold value (e.g., when the calculated value is within a threshold value based on a preset control data) at operation 245, then the controller 100 may proceed to operation 250 at which the controller 100 may adjust the position of the second window. The adjustment of the position of the second window may include an X-axis or Y-axis movement method, a reduction method, a through method, a flipping pages method, a grid movement method, and/or the like. A description of the adjustment will be described later in more detail with reference to diagrams.

According to various embodiments of the present disclosure, when the user input for the second app is not detected during the first execution of the first app, the controller 100 may control to perform the operation of the first app at operation 255. According to various embodiments of the present disclosure, when the execution of the pop-up window position adjustment module 102 is not detected, the controller 100 may control to perform the operation according to a corresponding multitasking at operation 255.

According to various embodiments of the present disclosure, when the distance between the user input position information in the first window and the position of the second window is maintained (e.g., calculated value ≧ threshold value) even though multitasking is performed through the pop-up window position adjustment module 102, the controller 100 may control to maintain the current position of the second window at operation 255.

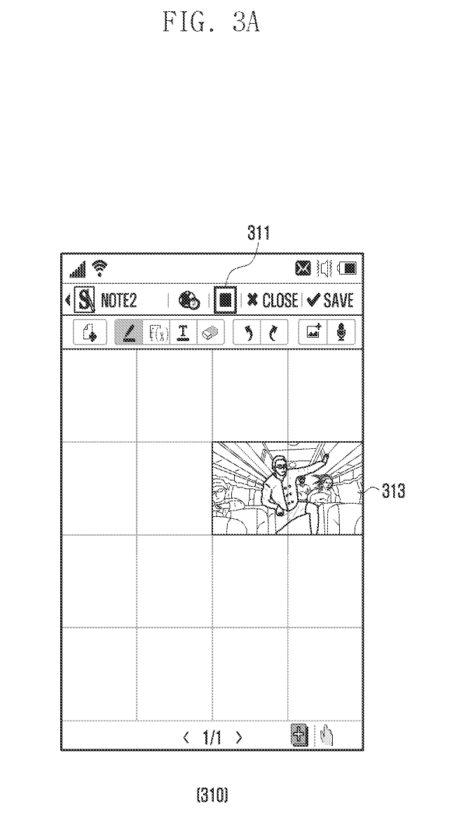

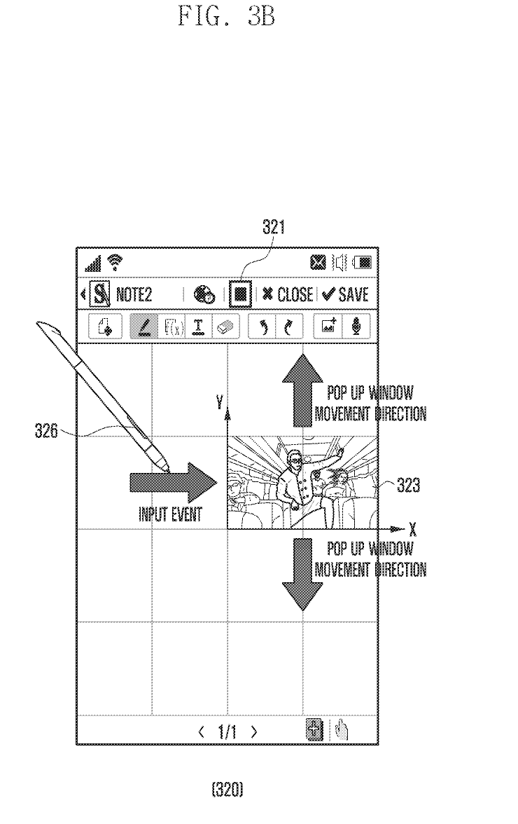

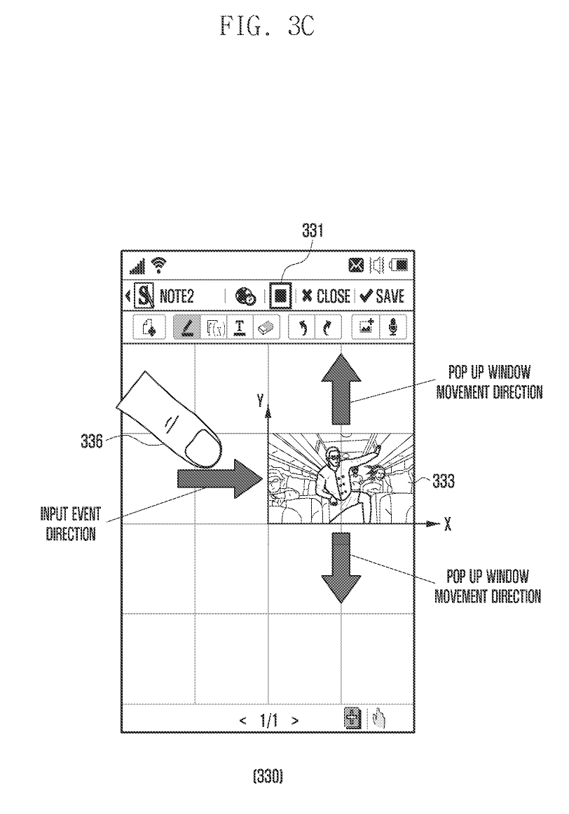

FIGS. 3A, 3B, and 3C are diagrams illustrating a method of operating a pop-up window when an electronic device executes multitasking according to an embodiment of the present disclosure.

Referring to FIG. 3A, the controller 100 may control to divide the touch panel 114 for detecting the user input into a 4*4 grid as illustrated in screen 310. Further, the controller 100 may detect a frequency of use for each grid divided into 4*4. Further, the controller 100 may recognize, as illustrated in relation to reference numeral 313, that the output value for a grid of position of the second window (e.g., a pop-up window according to a video watching) is higher than other grid.

The 4*4 grid is a method of supporting a grid size according to various embodiments of the present disclosure. However, the 4*4 grid is an example of a grid size and various embodiments of the present disclosure are not limited thereto. The supporting of the grid size may support various grid sizes which divide the touch panel 114 for detecting the user input into a 2*2, 3*3, 4*4, n*n, m*n, and/or the like.

The controller 100 may provide, as illustrated in relation to reference numeral 311, a touch input area (e.g., an icon) for using the pop-up window position adjustment module 102. The execution of the pop-up window position adjustment module 102 is not limited to the touch input, but may be supported through the voice input, the key input, and/or the like.

Referring to FIG. 3B, the controller 100 may display, as illustrated in screen 320, the first window (e.g., a main window according to use of S-note) and the second windows (e.g., a pop-up window according to a video watching) on the display unit 112. In addition, the controller 100 may detect the user input in the first window through the touch panel 114. An input means according to the user input may be a touch pen 326, and/or the like. The controller 100 may identify the input means (e.g., a touch pen or a finger, and/or the like) such as a touch pen to detect. The controller 100 may provide, as illustrated in relation to reference numeral 321, a touch input area (e.g., an icon) for using the pop-up window position adjustment module 102.

Assuming that the first window is an app for S-note, the controller 100 may detect the user input in the S-note. The user input may be directed, as illustrated in relation to reference numeral 323, to the second window (e.g., a pop-up window for watching video). The controller 100 may detect the position information according to the user input. Further, the controller 100 may detect the position according to the position of the second window. Further, the controller 100 may adjust the position of the second window through the pop-up window position adjustment module 102. For example, a drawing according to user input may be assumed to be moved from touch coordinate (80, 150) to touch coordinate (100, 150) via touch coordinate (90, 150) based on the X axis of coordinate value. At this time, the second window may include touch coordinate (100, 150) to display.

If the user input is continuously performed, then the drawing may be executed in the second window. The controller 100 may adjust the position of the second window through the pop-up window position adjustment module 102. When the user input position information approaches at least one of four sides of the second window, four corners, an output value, a center point connecting four sides or four corners, and/or the like in the first window, the pop-up window position adjustment module 102 may automatically control the position of the second window in an X or Y axis direction under the control of the controller 100.

Referring to FIG. 3C, as illustrated in screen 330, the controller 100 may detect the user input for a finger 336, and/or the like. Further, the controller 100 may identify the input means (e.g., a finger, a touch pen, and/or the like) such as a finger. The finger 336 may have a wider touch area compared with the touch pen 326. In the above case, the pop-up window position adjustment module 102 may extend the range of recognition of control data. The controller 100 may provide, as illustrated in relation to reference numeral 331, a touch input area (e.g., an icon) for using the pop-up window position adjustment module 102.

For example, when the user input in the first window (e.g., a main window according to an execution of a memo function) is directed to the second window (e.g., a pop-up window for watching video) as illustrated in relation to reference numeral 333, the controller 100 may support the control data according to each input means for the user input. For example, assuming that the recognition range by the touch pen supported through the pop-up window position adjustment module 102 is 3 cm, 2 cm, 1 cm, or the like, the finger may be supported in more wide form such as 4 cm, 3 cm, 2 cm, or the like.

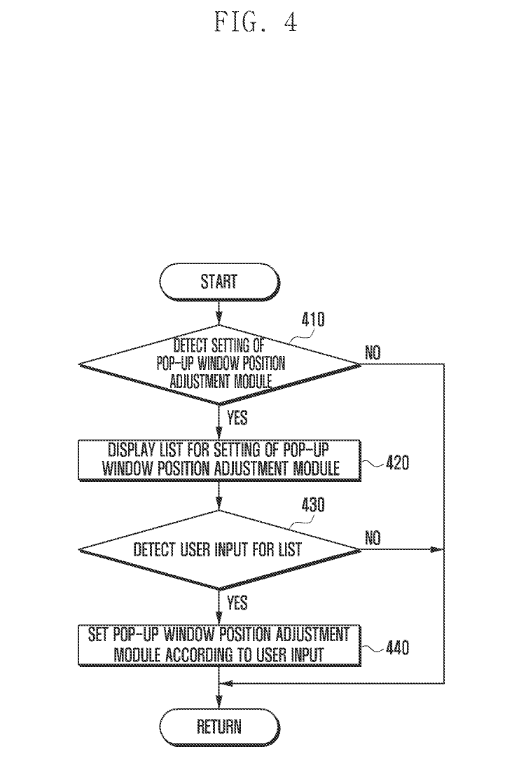

FIG. 4 is a flowchart illustrating a setting for a method of operating a pop-up window when an electronic device executes multitasking according to an embodiment of the present disclosure.

Referring to FIG. 4, the controller 100 may detect the user input for the setting of the pop-up window position adjustment module.

At operation 410, the controller 100 may determine whether the user input for the setting of the pop-up window position adjustment module is detected.

If the controller 100 determines that the user input for the setting of the pop-up window position adjustment module is not detected at operation 410, then the controller 100 may end the method of operating a pop-up window when an electronic device executes multitasking.

In contrast, if the controller 100 determines that the user input for the setting of the pop-up window position adjustment module is detected (e.g., when the user input is detected) at operation 410, then the controller 100 may proceed to operation 420 at which the controller 100 may display a list for the setting of the pop-up window position adjustment module on the display unit 112. The list may include an X-axis or a Y-axis movement method, a reduction method, a through method, a flipping pages method, a grid movement method, and/or the like. A description of the above methods will be described later in detail with reference to diagrams.

When the list for the setting of the pop-up window position adjustment module is displayed, the controller 100 may detect the user input for a corresponding list.

At operation 430, the controller 100 may determine whether a user input for a corresponding list is detected.

If the controller 100 determines that the user input for the corresponding list is not detected at operation 430, then the controller 100 may end the method of operating a pop-up window when an electronic device executes multitasking.

In contrast, if the controller 100 determines that the user input for the corresponding list is detected (e.g., when the user input for the list is detected) at operation 430, then the controller 100 may proceed to operation 440 at which the controller 100 may set the pop-up window position adjustment module according to the user input.

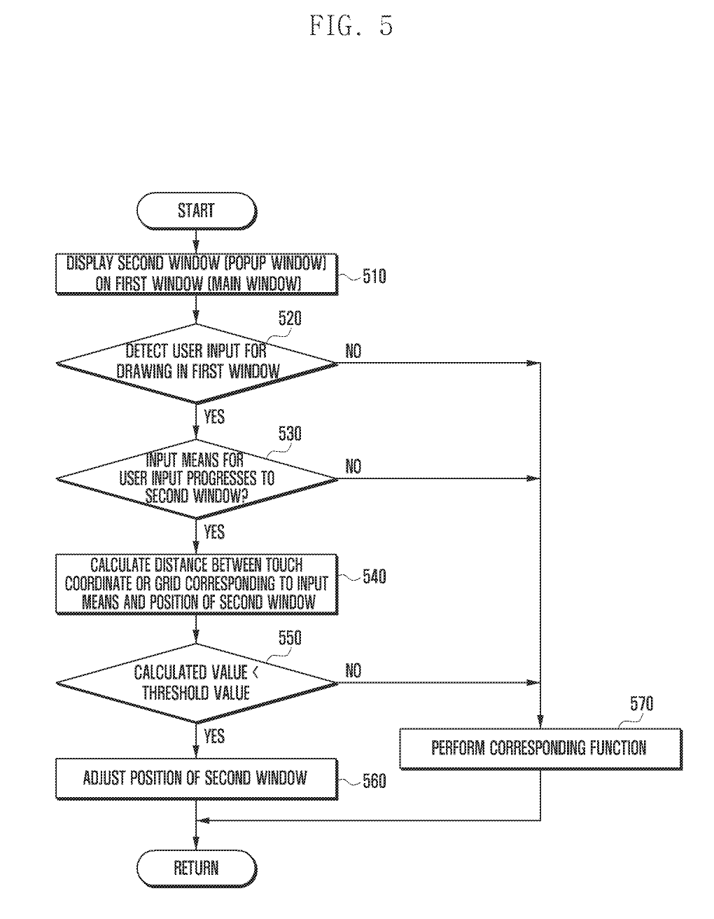

FIG. 5 is a flowchart illustrating a method of operating a pop-up window according to a drawing when an electronic device executes multitasking according to an embodiment of the present disclosure.

Referring to FIG. 5, at operation 510, the controller 100 may display the second window (e.g., a popup window) on the first window (e.g., a main window) through the display unit 112.

The controller 100 may detect the user input for drawing in the first window.

At operation 520, the controller 100 may determine whether the user input for drawing in the first window is detected.

If the controller 100 determines that the user input for drawing in the first window is not detected at operation 520, then the controller 100 may proceed to operation 570 at which the controller 100 may perform a corresponding function.

In contrast, if the controller 100 determines that the user input for drawing in the first window is detected (e.g., when the user input is detected) at operation 520, then the controller 100 may detect the input means for the user input. Further, the controller 100 may detect the direction in which the input means progresses. The detection of the progress direction may be supported through the touch coordinate or the grid.

At operation 530, the controller 100 may determine whether the input means for user input progresses to the second window.

If the controller 100 determines that the input means for user input does not progress to the second window at operation 530, then the controller 100 may proceed to operation 570 at which the controller 100 may perform a corresponding function.

In contrast, if the controller 100 determines that the input means for user input does not progress to the second window at operation 530, then the controller 100 may proceed to operation 540 at which the controller 100 may calculate a distance between a touch coordinate or a grid corresponding to the input means and the position of the second window. The distance calculation may be performed through the pop-up window position adjustment module 102. The controller 100 may compare the calculated distance between a touch coordinate or a grid corresponding to the input means and the position of the second window with a threshold value.

At operation 550, the controller 100 may determine whether the calculated value is less than the threshold value. For example, the controller 100 may determine whether the calculated distance between a touch coordinate or a grid corresponding to the input means and the position of the second window is less than the threshold value.

If the controller 100 determines that the calculated value is not less than the threshold value at operation 550, then the controller 100 may proceed to operation 570 at which the controller 100 may perform a corresponding function.

In contrast, if the controller 100 determines that the calculated value is less than the threshold value (e.g., when the calculated value of the distance is within the threshold value) at operation 550, then the controller 100 may proceed to operation 560 at which the controller 100 may adjust the position of the second window. A detailed description of the adjustment will be described later in more detail with reference to examples described later.

According to various embodiments of the present disclosure, when the user input according to the drawing is not detected in the first window at operation 520, the controller 100 may maintain the standby state for detecting the user input or return at operation 570.

According to various embodiments of the present disclosure, when the input means according to the user input is not progressed to the second window in the first window at operation 530, the controller 100 may maintain the position of the second window at operation 570.

According to various embodiments of the present disclosure, when the calculated value is a threshold value or more at operation 550, the controller 100 may maintain the position of the second window at operation 570.

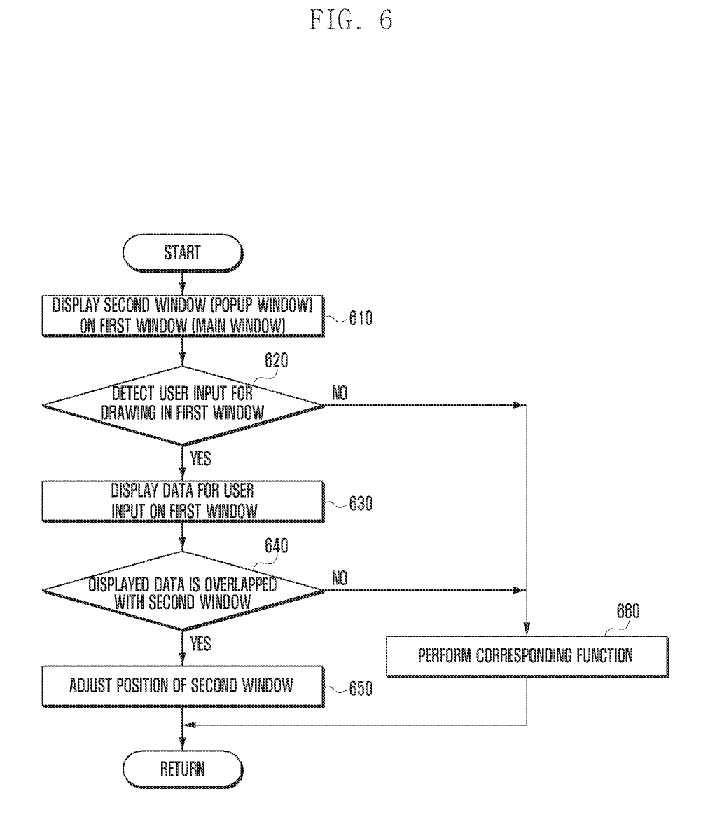

FIG. 6 is a flowchart for determining whether a data according to a drawing is overlapped with a second window when an electronic device executes multitasking according to an embodiment of the present disclosure.

Referring to FIG. 6, at operation 610, the controller 100 may display the second window (e.g., a popup window) on the first window (e.g., a main window) through the display unit 112. The controller 100 may detect the user input for drawing in the first window.

At operation 620, the controller 100 may determine whether a user input for drawing in the first window is detected.

If the controller 100 determines that a user input for drawing in the first window is not detected at operation 620, then the controller 100 may proceed to operation 660 at which the controller 100 performs a corresponding function.

In contrast, if the controller 100 determines that a user input for drawing in the first window is detected (e.g., when the user input is detected) at operation 620, then the controller 100 may proceed to operation 630 at which the controller 100 may display the data corresponding to the user input on the display unit 112.

When the data is displayed, the controller 100 may recognize (e.g., determine) whether the data is overlapped with the second window.

At operation 640, the controller 100 determines whether the displayed data is overlapped with the second window.

If the controller 100 determines that the displayed data is not overlapped with the second window at operation 640, then the controller 100 may proceed to operation 660 at which the controller 100 performs a corresponding function.

In contrast, if the controller 100 determines that the displayed data is overlapped with the second window (e.g., when the data is overlapped with the second window) at operation 640, then the controller 100 may proceed to operation 650 at which the controller 100 may adjust the position of the second window. A detailed description of the adjustment will be described later in more detail with reference to examples described later.

According to various embodiments of the present disclosure, when the user input according to drawing is not detected in the first window, the controller 100 may maintain the standby state for detecting the user input or return at operation 660.

According to various embodiments of the present disclosure, when the data is not overlapped with the second window, the controller 100 may maintain the position of the second window at operation 660.

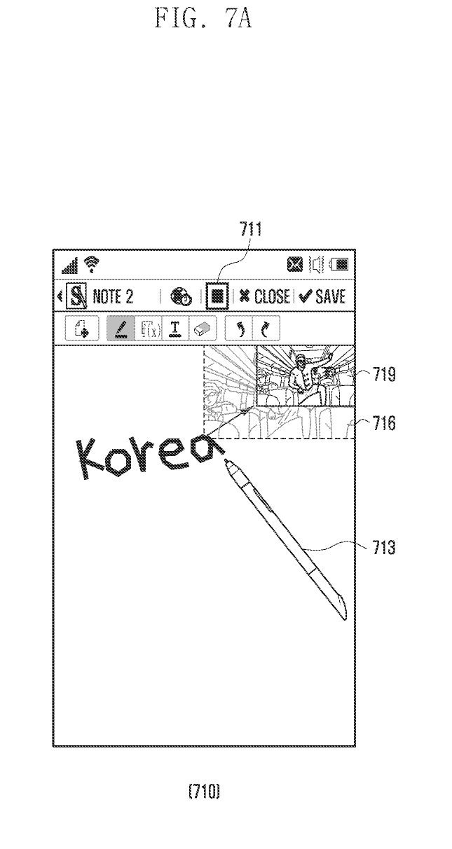

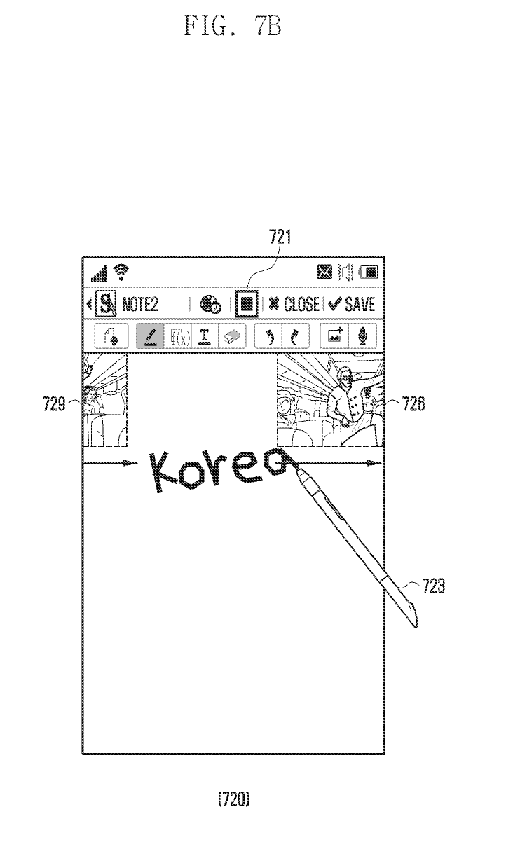

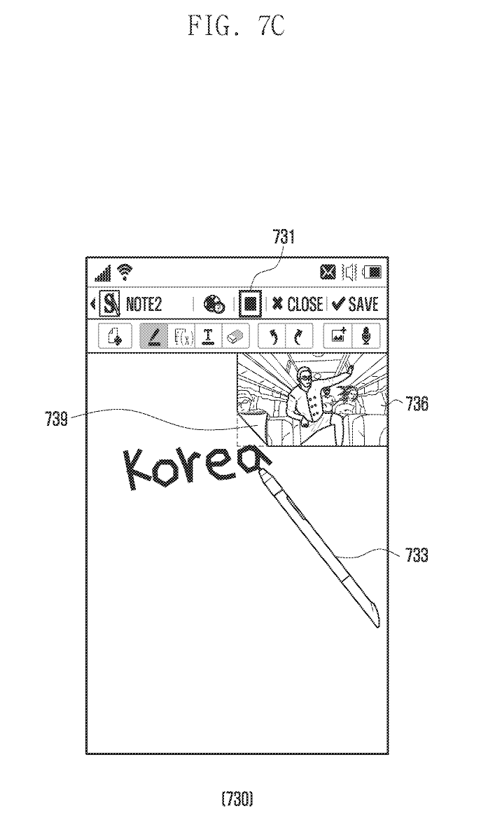

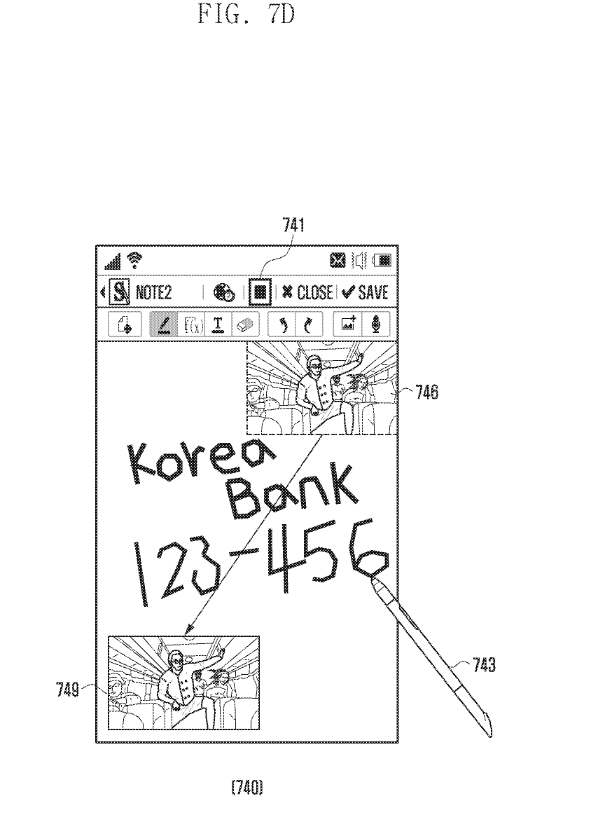

FIGS. 7A, 7B, 7C, and 7D are diagrams illustrating a method of operating a pop-up window according to a user input when an electronic device executes multitasking according to an embodiment of the present disclosure.

Referring to FIG. 7A, as illustrated in screen 710, the controller 100 may display the second window (e.g., a pop-up window according to a video watching) on the first window (e.g., a main window according to a use of S-note) through the display unit 112. The controller 100 may detect the user input (e.g., a drawing) in the first window. The controller 100 may provide, as illustrated in relation to reference numeral 711, a touch input area (e.g., an icon) for using the pop-up window position adjustment module 102.

When the input means 713 for the user input is directed to the second window 716, the controller 100 may reduce the second window through the reduction method of the pop-up window position adjustment module 102. The controller 100 may detect the progress direction of the input means for the user input through the touch panel 114. The detection may be supported through the touch coordinate or the grid. The reduction method reduces the second window from window 716 to window 719, when the input means approaches the position of the second window in the progress direction through the pop-up window position adjustment module 102. The position may be four sides of the second window, four corners, an output value, or a center point connecting four sides or four corners, and/or the like. When the user input is deviated from a corresponding position, the second window may return to original position from window 719 to window 716.

Referring to FIG. 7B, as illustrated in screen 720, the controller 100 may display the second window (e.g., a pop-up window according to a video watching) on the first window (e.g., a main window according to a use of S-note) through the display unit 112. The controller 100 may detect the user input (e.g., a drawing) in the first window. The controller 100 may provide, as illustrated in relation to reference numeral 721, a touch input area (e.g., an icon) for using the pop-up window position adjustment module 102.

When the input means 723 for the user input is directed to the second window, the controller 100 may adjust the second window through the through method of the pop-up window position adjustment module 102. For example, when the user input is directed to the second window in the first window, the controller 100 may detect the user input, and may automatically move the second window. The direction of the automatic movement may be the same as the direction of the user input. For example, if the user input moves in the direction of the x axis, then, the automatic movement direction of the second window may also be the x-axis direction. According to various embodiments of the present disclosure, when the automatic movement reaches the edge of the screen, the controller 100 may detect this and push the second window through from the edge of the screen to the opposite edge by the through method. According to the example of screen 720, when the user input 723 approaches the second window, the controller 100 may control to change the second window from window 726 to window 729 so that the second window may pass the edge of the screen and be generated again from the opposite edge.

Referring to FIG. 7C, as illustrated in screen 730, the controller 100 may display the second window (e.g., a pop-up window according to a video watching) on the first window (e.g., a main window according to a use of S-note) through the display unit 112. The controller 100 may detect the user input (e.g., a drawing) in the first window. The controller 100 may provide, as illustrated in relation to reference numeral 731, a touch input area (e.g., an icon) for using the pop-up window position adjustment module 102.

When the input means 733 for the user input is directed to the second window 736, the controller 100 may lift up the second window 736 as flipping pages through the flipping pages method of the pop-up window position adjustment module 102.

According to the example of screen 730, when the user input is directed to the second window 736 in the first window, the controller 100 may lift up the second window 736 as much as the user input from window 736 to window 739 through the flipping pages method of the pop-up window position adjustment module 102. Further, when the user input is deviated from a corresponding area, the controller 100 may return the second window 736 to original position from window 739 to window 736.

Referring to FIG. 7D, as illustrated in screen 740, the controller 100 may display the second window (e.g., a pop-up window according to a video watching) on the first window (e.g., a main window according to a use of S-note) through the display unit 112. The controller 100 may detect the user input (e.g., a drawing) in the first window. The controller 100 may provide, as illustrated in relation to reference numeral 741, a touch input area (e.g., an icon) for using the pop-up window position adjustment module 102.

When the input means 743 for the user input is directed to the second window 746, the controller 100 may move the second window through the grid by the grid movement method of the pop-up window position adjustment module 102.

When the user input is directed to the second window in the first window, the controller 100 may automatically adjust the second window 746 from window 746 to window 749 through the grid movement method of the pop-up window position adjustment module 102. The grid movement method assigns a grid size such as 2*2, 3*3, 4*4, n*n, m*n, or the like with respect to the touch coordinate detected through the touch panel 114, extracts the frequency of use for the grid, and adjusts the second window by the grid having a low frequency of use.

In more detail, the controller 100 may recognize the frequency of use of the assigned grid sizes such as 2*2, 3*3, 4*4, n*n, m*n, or the like through the pop-up window position adjustment module 102. Assuming that the 4*4 grid type is supported as the grid size, the controller 100 may recognize that the second window 746 is located in a grid (e.g., grid (4, 3) and grid (4, 4)) as illustrated in window 746. When the user input is directed to the second window 746 in the first window, the controller 100 may detect that the user input is directed to the second window 746 and move the second window 746 to the grid having a low frequency of use (e.g., grid (1, 1) and grid (1, 2)).

In case of the movement of the second window, it may be considered whether the displayed data which is mentioned at operation 640 of FIG. 6 is overlapped with the second window. The controller 100 may move the second window according to the position adjustment of the pop-up window to the grid which is not overlapped with the displayed data. The controller 100 may recognize the frequency of use of grids, detect an event according to the data output, and adjust the position of the second window through the pop-up window position adjustment module 102 so that the displayed data may not be overlapped with the output of the second window.

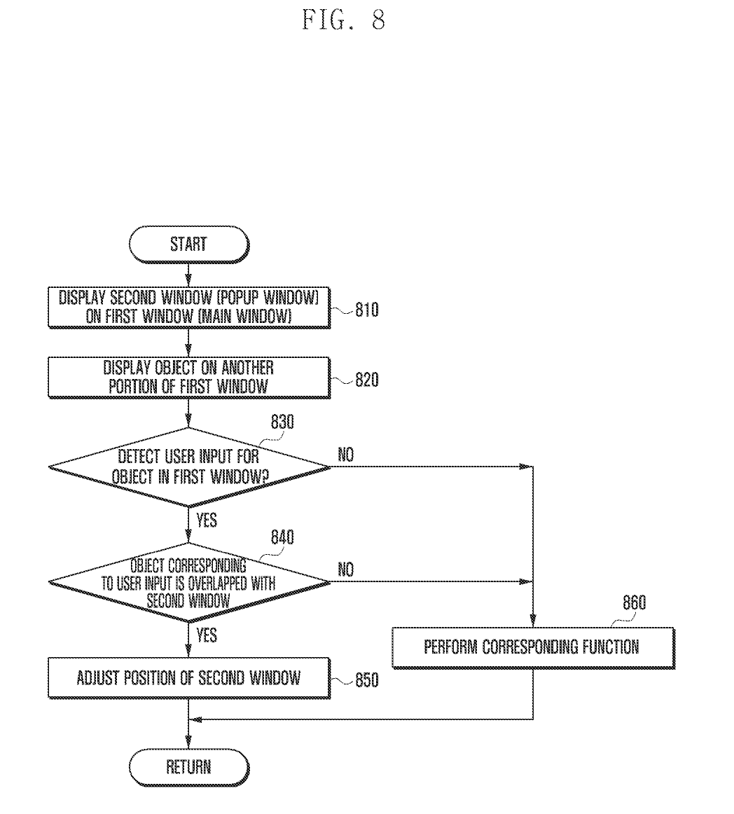

FIG. 8 is a flowchart for determining whether an object according to a web page search is overlapped with a second window when an electronic device executes multitasking according to an embodiment of the present disclosure.

Referring to FIG. 8, at operation 810, the controller 100 may display the second window (e.g., a pop-up window according to a video watching) on the first window (e.g., a main window according to a web page search) through the display unit 112.

At operation 820, the controller 100 may display various objects according to a use of the first window (e.g., a web page search) on another portion of the first window. The controller 100 may detect the user input for the various objects.

At operation 830, the controller 100 may determine whether a user input for an object in the first window is detected.

If the controller 100 determines that the user input for the object in the first window is not detected at operation 830, then the controller 100 may proceed to operation 860 at which the controller 100 performs a corresponding function.

In contrast, if the controller 100 determines that the user input for the object in the first window is detected (e.g., when the user input is detected) at operation 830, then the controller 100 may proceed to operation 840 at which the controller 100 may determine whether the object corresponding to the user input is overlapped with the second window (e.g., through the pop-up window position adjustment module 102).

If the controller 100 determines that the object corresponding to user input is not overlapped with the second window at operation 840, then the controller 100 may proceed to operation 860 at which the controller 100 performs a corresponding function.

In contrast, if the controller 100 determines that the object corresponding to user input is overlapped with the second window (e.g., when the object corresponding to the user input is overlapped with the second window) at operation 840, then the controller 100 may proceed to operation 850 at which the controller 100 may adjust the position of the second window. A detailed description of the adjustment will be described in more detail through diagrams.

According to various embodiments of the present disclosure, when the controller 100 does not detect the user input at operation 830, the controller 100 may maintain the standby state for detecting the user input or return at operation 860.

According to various embodiments of the present disclosure, when the user input is not overlapped with the second window at operation 840, the controller 100 may maintain the position of the second window at operation 860.

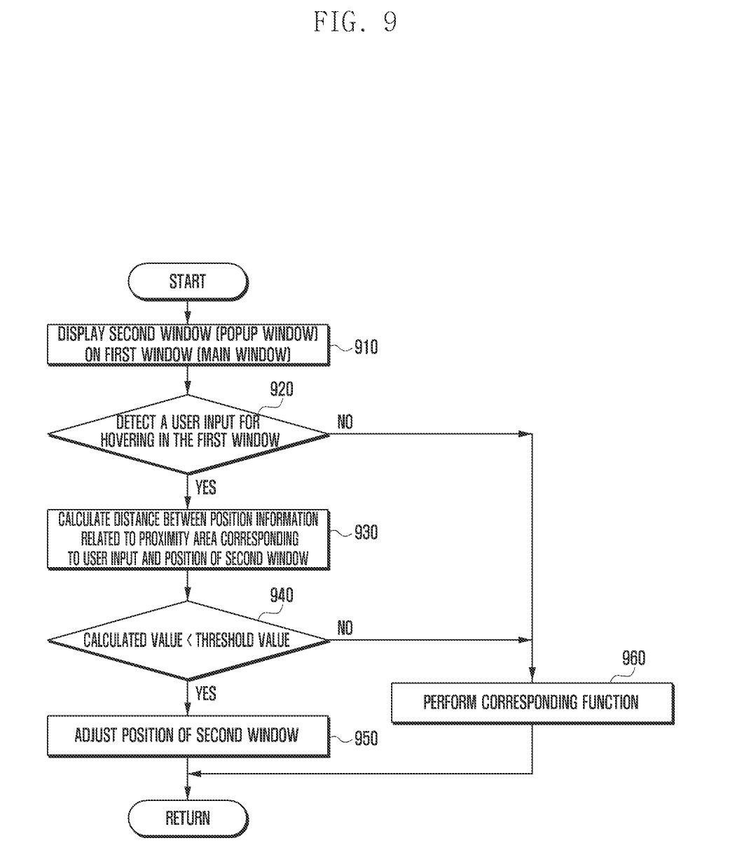

FIG. 9 is a flowchart illustrating a method of operating a pop-up window according to a hovering when an electronic device executes multitasking according to an embodiment of the present disclosure.

Referring to FIG. 9, at operation 910, the controller 100 may display the second window (e.g., a pop-up window according to a video watching) on the first window (e.g., a main window according to a web page search) through the display unit 112.

The controller 100 may detect a user input tool for hovering in the first window. The input tool may be a finger or a touch pen.

Further, the controller 100 may detect position information related to a proximity area corresponding to the user input. The position information related to a proximity area may be differently detected according to touch pen and finger. For example, in case of a finger, it may include a wider touch area compared with the touch pen.

At operation 920, the controller 100 may determine whether a user input for hovering in the first window is detected.

If the controller 100 determines that a user input for hovering in the first window is not detected at operation 920, then the controller 100 may proceed to operation 960 at which the controller 100 performs a corresponding function.

In contrast, if the controller 100 determines that a user input for hovering in the first window is detected at operation 920, then the controller 100 may proceed to operation 930 at which the controller 100 may calculate a distance between the position information related to a proximity area corresponding to the user input and the position of the second window. The calculated distance may be the distance between the position information (e.g., a touch coordinate or a grid, and/or the like) for the user input (e.g., hovering) and the position of the second window (e.g., four edges, four corners, an output value, or a center point connecting four sides or four corners, and/or the like).

At operation 940, the controller 100 may determine whether the calculated value is less than a threshold value (e.g., whether the calculated distance between the position information related to a proximity area corresponding to the user input and the position of the second window is less than a threshold value).

If the controller 100 determines that the calculated value is not less than a threshold value (e.g., that the calculated distance between the position information related to a proximity area corresponding to the user input and the position of the second window is not less than a threshold value) at operation 940, then the controller 100 may proceed to operation 960 at which the controller 100 performs a corresponding function.

In contrast, if the controller 100 determines that the calculated value is less than the threshold value (e.g. that the calculated value is less than the threshold value stored in the pop-up window position adjustment module 102) at operation 940, then the controller 100 may proceed to operation 950 at which the controller 100 may control to adjust the position of the second window. A detailed description of the adjustment will be described later in detail with reference to diagrams.

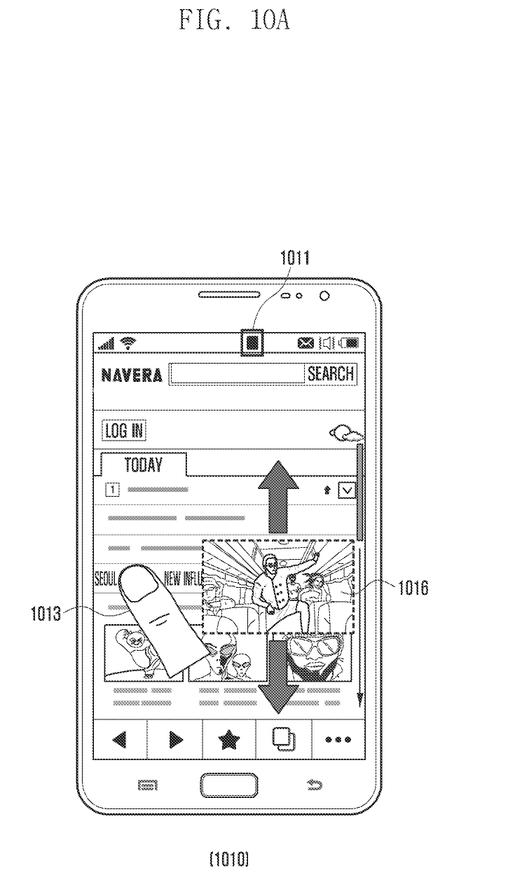

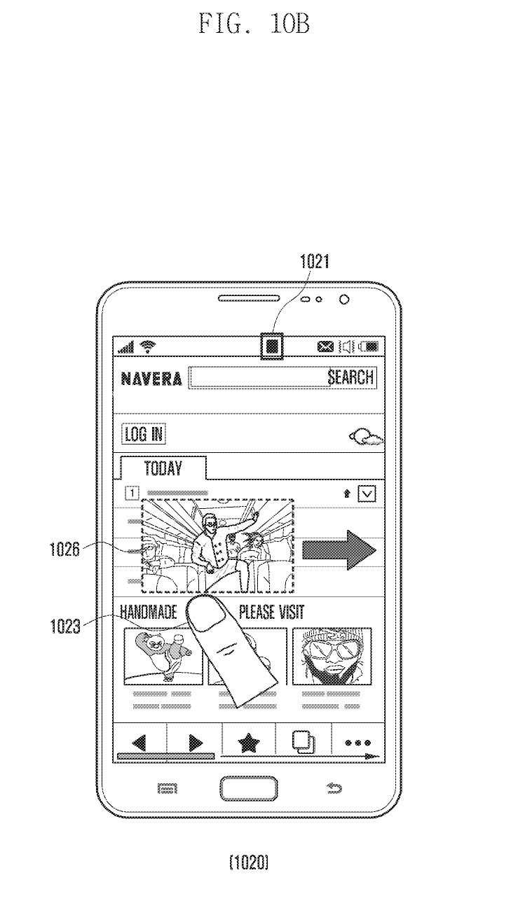

FIGS. 10A and 10B are diagrams illustrating user inputs according to a web page search when an electronic device executes multitasking according to an embodiment of the present disclosure.

Referring to FIG. 10A, as illustrated in screen 1010, the controller 100 may display the second window (e.g., a pop-up window according to a video watching) on the first window (e.g., a main window according to a web page search) through the display unit 112. Further, the controller 100 may display various objects according to a use of the first window on another portion of the first window. The controller 100 may provide, as illustrated in relation to reference numeral 1011, a touch input area (e.g., an icon) for using the pop-up window position adjustment module 102.

The controller 100 may detect the user input in the first window. The user input may be a hovering 1013. For example, when the user input hovers on a specific title (e.g., object) among the search list in the web page, the controller 100 may detect a corresponding title through the hovering. When the specific title among the search list is overlapped with the second window 1016, the controller 100 may adjust the second window 1016 through the pop-up window position adjustment module 102. The adjustment may be implemented by automatically adjusting the second window 1016 in an upward or downward direction within a range in which the specific title (e.g., object) is not overlapped under the control of the controller 100. In the above-mentioned case, the displayed specific title (e.g., object) may be displayed on the display unit 112 with a full title not with part of the title.

Referring to FIG. 10B, as illustrated in screen 1020, the controller 100 may display the second window (e.g., a pop-up window according to a video watching) on the first window (e.g., a main window according to a web page search) through the display unit 112. Further, the controller 100 may display various objects according to a use of the first window on another portion of the first window. The controller 100 may provide, as illustrated in relation to reference numeral 1021, a touch input area (e.g., an icon) for using the pop-up window position adjustment module 102.

The controller 100 may detect the user input in the first window. The user input may be a flicking, a scrolling 1023, and/or the like.

When the user input is detected, the controller 100 may identify (e.g., determine) the input means for the user input (e.g., a finger or a touch pen, and/or the like). Further, the controller 100 may detect the movement direction of the input means through the touch panel 114. When the movement direction 1023 of the input means is directed to the second window 1026, the controller 100 may automatically adjust the second window 1026 so that the second window 1026 may move out of the range of the movement direction 1023 of the input means through the pop-up window position adjustment module 102. The adjustment may be supported by an X-axis or Y-axis movement method, a reduction method, a through method, a flipping pages method, a grid movement method, and/or the like.

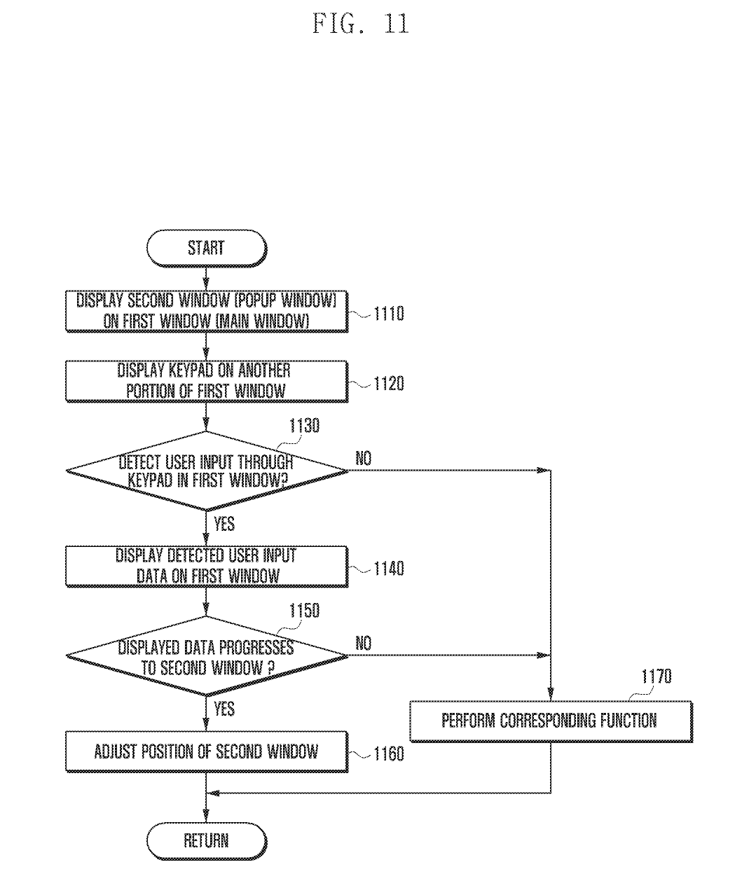

FIG. 11 is a flowchart illustrating a method of operating a pop-up window according to a user input through a keypad when an electronic device executes multitasking according to an embodiment of the present disclosure.

Referring to FIG. 11, at operation 1110, the controller 100 may display the second window (e.g., a pop-up window according to a video watching) on the first window (e.g., a main window according to a transmission and reception of a Social Networking Service (SNS) event, a Short Messaging Service (SMS) message, a use of KakaoTalk, and/or the like) through the display unit 112.

At operation 1120, the controller 100 may display a keypad in another portion of the first window.

The controller 100 may detect the user input through the keypad displayed on the first window.

At operation 1130, the controller 100 may determine whether a user input through a keypad in the first window is detected.

If the controller 100 determines that a user input through a keypad in the first window is not detected at operation 1130, then the controller 100 may proceed to operation 1170 at which the controller 100 performs a corresponding function.

In contrast, if the controller 100 determines that a user input through a keypad in the first window is detected at operation 1130, then the controller 100 may proceed to operation 1140 at which the controller 100 may display user input data according to a use of the key pad on another part of the first window. For example, the controller 100 may display the detected user input data on the first window.

The displayed data may progress to the second window. The controller 100 may detect the displayed data, and may detect the position according to the use of the second window.

At operation 1150, the controller 100 determines whether the displayed data progresses to the second window.

If the controller 100 determines that the displayed data does not progress to the second window at operation 1150, then the controller 100 may proceed to operation 1170 at which the controller 100 performs a corresponding function.

In contrast, if the controller 100 determines that the displayed data progresses to the second window (e.g., when the displayed data is progressed to the second window) at operation 1150, the controller 100 may proceed to operation 1160 at which the controller 100 may adjust the position of the second window. For example, the controller 100 may adjust the position of the second window in an upward or progress direction through the pop-up window adjustment module 102.

According to various embodiments of the present disclosure, when the user input through the keypad is not detected at operation 1130, the controller 100 may maintain the standby state for detecting the user input or return at operation 1170. According to various embodiments of the present disclosure, when the displayed data is not progressed to the second window at operation 1150, the controller 100 may maintain the current position of the second window at operation 1170.

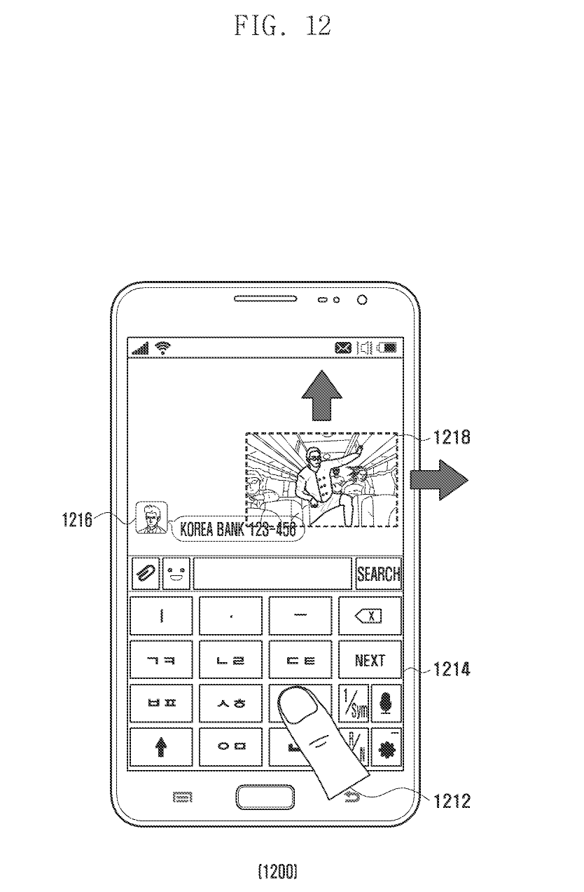

FIG. 12 is a diagram illustrating a method of operating a pop-up window according to a user input through a keypad when an electronic device executes multitasking according to an embodiment of the present disclosure.

Referring to FIG. 12, as illustrated in screen 1200, the controller 100 may display the second window (e.g., a pop-up window according to a video watching) on the first window (e.g., a main window according to a transmission and reception of SNS event, an SMS message, a use of KakaoTalk, and/or the like) through the display unit 112 as illustrated in reference numeral 1200. The display unit 112 may include a keypad 1214. Further, the display unit 112 may display the user input using input means 1212 (e.g., a user's finger, a stylus, and/or the like) in a form of data 1216 on another portion of the first window as illustrated in reference numeral 1216 under control of the controller 100. When the data 1216 is overlapped with the second window 1218, the controller 100 may adjust the position of the second window 1218 in an upward or progress direction through the pop-up window adjustment module 102. Further, the controller 100 may be supported through an X-axis or Y-axis movement method, a reduction method, a through method, a flipping pages method, a grid movement method, and/or the like.

As described, according to a method and an apparatus for operating a pop-up window of an electronic device of the present disclosure, when performing multiple tasking, if the user input directs to the pop-up window, the pop-up window may be adjusted to decrease the inconvenience of manually moving the pop-up window. In addition, when operating the pop-up window, the user may experience fun and interesting.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure, as defined by the appended claims and their equivalents.

What is claimed is:

1. A method of operating a window of an electronic device having a touch screen, the method comprising:
displaying a second window on a part of a first window;
detecting a user input in the first window; and
adjusting a position of the second window, when a distance between a position of the user input for the first window and the position of the second window is a preset threshold value or less.

2. The method of claim 1, wherein the adjusting of the position of the second window comprises:
determining whether the second window is a preset specific window;
if the second window is the preset specific window, adjusting a position of the second window when the distance is the threshold value or less.

3. The method of claim 2, wherein the preset specific window is a video play window.

4. The method of claim 1, wherein the detecting of the user input in the first window comprises determining an input means used for the user input.

5. The method of claim 1, wherein the adjusting of the position of the second window comprises at least one of:
moving the second window;
adjusting the second window by a reduction method;
adjusting the second window by a through method;
adjusting the second window by a flipping pages method; and
adjusting the second window by a grid movement method.

6. The method of claim 1, further comprising:
adjusting a position of the second window, when an object corresponding to the user input is overlapped with the second window, in the first window.

7. The method of claim 1, further comprising:
displaying a data according to the user input in the first window;
determining whether the displayed data is overlapped with the second window position; and
adjusting the position of the second window when the data is overlapped with the position of the second window.

8. The method of claim 1, further comprising:
displaying a data according to the user input in the first window; and
adjusting the position of the second window when the displayed data is progressed to the position of the second window.

9. An electronic device having a touch screen, the electronic device comprising:
a display unit configured to display a second window on a first window;
a touch panel configured to detect a user input in the first window;
a pop-up window position adjustment module configured to determine whether a distance between a position of the user input for the first window and a position of the second window is a preset threshold value or less; and
a controller configured to control to adjust the position of the second window, when the distance is the preset threshold value or less as a result of the determination of the pop-up window position adjustment module.

10. The electronic device of claim 9, wherein the controller determines whether the second window is a preset specific window, and if the second window is the preset specific window, adjusts a position of the second window when the distance is the threshold value or less.

11. The electronic device of claim 10, wherein the preset specific window is a video play window.

12. The electronic device of claim 9, wherein the controller controls to determine an input means used for the user input.

13. The electronic device of claim 9, wherein the controller controls at least one of operations of:
moving the second window;
adjusting the second window by a reduction method;
adjusting the second window by a through method;
adjusting the second window by a flipping pages method; and
adjusting the second window by a grid movement method.

14. The electronic device of claim 9, wherein the controller adjusts a position of the second window, when an object corresponding to the user input is overlapped with the second window, in the first window.

15. The electronic device of claim 9, wherein the controller displays a data according to the user input in the first window, determines whether the displayed data is overlapped with the second window position, and adjusts the position of the second window when the data is overlapped with the position of the second window.

16. The electronic device of claim 9, wherein the controller displays a data according to the user input in the first window, and adjusts the position of the second window when the displayed data is progressed to the position of the second window.

17. A method of automatically operating a window of a electronic device having a touch screen, the method comprising:
displaying a first window;
displaying at least a part of a second window so as to overlap at least a part of the first window; and
adjusting a display of the second window according to at least one of a user input to the first window, new information received in relation to the first window, and information being displayed in the first window.

18. The method of claim 17, wherein the adjusting of the display of the second window comprises adjusting at least one of a size, a shape, and a position of at least a part of the second window.

19. The method of claim 18, further comprising:
receiving information to be displayed in the first window;
determining whether a current display of the second window would interfere with visibility of the received information to be displayed in the first window; and
adjusting the display of the second window in response to determining that the current display of the second window would interfere with visibility of the received information to be displayed in the first window.

20. The method of claim 19, wherein the current display of the second window is determined to interfere with visibility of the received information to be displayed in the first window if at least a part of the second window would overlap with the received information to be displayed in the first window.
